(19) United States
(12) Patent Application Publication
(10) Pub. No.: US 2017/0363994 A1
(43) Pub. Date: Dec. 21, 2017

(54) LINEAR LIGHT CONCENTRATOR, FIXING DEVICE AND IMAGE FORMING APPARATUS

(71) Applicant: FUJI XEROX CO., LTD., Tokyo (JP)

(72) Inventor: Yoshiya IMOTO, Kanagawa (JP)

(73) Assignee: FUJI XEROX CO., LTD., Tokyo (JP)

(21) Appl. No.: 15/354,216

(22) Filed: Nov. 17, 2016

(30) Foreign Application Priority Data
Jun. 21, 2016 (JP) 2016-122741

(51) Int. Cl. G03G 15/20; G02B 19/00

(52) U.S. Cl. CPC G03G 15/2007; G02B 19/0014; G02B 19/0047

(57) ABSTRACT

A linear light concentrator includes a light emitting body and first and second optical element groups, wherein the first optical element group is divided in first and second directions into first optical elements, each having characteristics to deflect a beam in the first direction, and the characteristics of the first optical elements adjacent in the second direction are different, the second optical element group is divided in at least the first direction into second optical elements having a power in the second direction, and center axes of refraction of adjacent second optical elements are shifted in the second direction, the characteristics deflect a beam from each unit of the first optical elements arranged in the first direction toward one of apertures of the second optical element group, and a length in the second direction of the second optical element is longer than that of the first optical element.

### CROSS REFERENCE TO RELATED APPLICATIONS

This application is based on and claims priority under 35 USC §119 from Japanese Patent Application No. 2016-122741 filed Jun. 21, 2016.

### BACKGROUND

### Technical Field

The present invention relates to a linear light concentrator, a fixing device and an image forming apparatus.

### Related Art

In recent years, light concentrators capable of concentrating laser light emitted from light emitting points arranged two-dimensionally to a linear region or point-shaped region are suggested.

### SUMMARY

According to an aspect of the present invention, there is provided a linear light concentrator including: a light emitting body in which light emitting surfaces are arranged in two directions; and a first optical element group and a second optical element group that are in different positions from each other related to an emission direction of the light emitting body, wherein the first optical element group is divided in a first direction and a second direction, which is different from the first direction, into first optical elements, each of the first optical elements having deflection characteristics to change an incident beam from the light emitting body to an exit beam deflected in the first direction, and deflection characteristics in the first direction of the first optical elements that are adjacent in the second direction are different from each other, at least one side of the second optical element group is divided in at least the first direction into second optical elements having powers in the second direction, and center axes of refracting action of the second optical elements adjacent to each other are disposed to be shifted in the second direction, when the plural first optical elements continuously arranged in the first direction are assumed to be a constitutional unit, the deflection characteristics of the first optical elements are such that a group of exit beams from each of the constitutional units is deflected toward a corresponding one of apertures of the second optical element group, and a length of the second optical element in the second direction is longer than a length of the first optical element in the second direction.

### BRIEF DESCRIPTION OF THE DRAWINGS

An exemplary embodiment of the present invention will be described in detail based on the following figures, wherein:

FIG. 1 is a diagram showing an image forming apparatus, to which the exemplary embodiment is applied, when viewed from a front side;

FIG. 2 is a diagram illustrating an outline configuration of a fixing device;

FIG. 3 is a perspective view illustrating a light concentrator of the fixing device;

FIGS. 4A to 4C are diagrams for illustrating a vertical cavity surface emitting laser unit;

FIG. 5 is a perspective view illustrating a bundle optical system;

FIGS. 6A and 6B are perspective views illustrating the bundle optical system: FIG. 6A is a view illustrating light guidance in (n−1)th stage in the bundle optical system; and FIG. 6B is a view illustrating light guidance in nth stage in the bundle optical system;

FIG. 6C is a perspective view illustrating light guidance in (n+1)th stage in the bundle optical system;

FIG. 7 is a perspective view illustrating the bundle optical system;

FIG. 8 is a perspective view illustrating sawtooth optical elements in a first optical element group;

FIG. 9 is a diagram illustrating a corresponding relation between bundled beams and block cylinder elements of a second optical element group;

FIGS. 10A and 10B are diagrams each illustrating a corresponding relation between bundled beams and block cylinder elements of the second optical element group: FIG. 10A shows a case of 20th stage; and FIG. 10B shows a case of 19th stage;

FIGS. 10C and 10D are diagrams each illustrating a corresponding relation between bundled beams and block cylinder elements of the second optical element group: FIG. 10C shows a case of 18th stage; and FIG. 10D shows a case of 17th stage;

FIG. 11 is a diagram illustrating a corresponding relation between bundled beams and block cylinder elements of a second optical element group;

FIGS. 12A and 12B are diagrams each illustrating a corresponding relation between bundled beams and block cylinder elements of the second optical element group: FIG. 12A shows a case of 16th stage; and FIG. 12B shows a case of 15th stage;

FIGS. 12C and 12D are diagrams each illustrating a corresponding relation between bundled beams and block cylinder elements of the second optical element group: FIG. 12C shows a case of 14th stage; and FIG. 12D shows a case of 13th stage;

FIGS. 13A to 13C are diagrams illustrating curvature of column-unit cylinders and showing radii of curvature different from one another;

FIG. 14 is a diagram illustrating light concentration by a correction cylinder and a transparent rod;

FIG. 15 is a diagram illustrating comparison of an object with an image thereof in reduced projection;

FIG. 16 is a perspective view illustrating a linear light concentrator; and

FIG. 17 is a diagram illustrating light concentration relation of a cylinder light concentration lens.

### DETAILED DESCRIPTION

Hereinafter, an exemplary embodiment according to the present invention will be described in detail with reference to attached drawings.

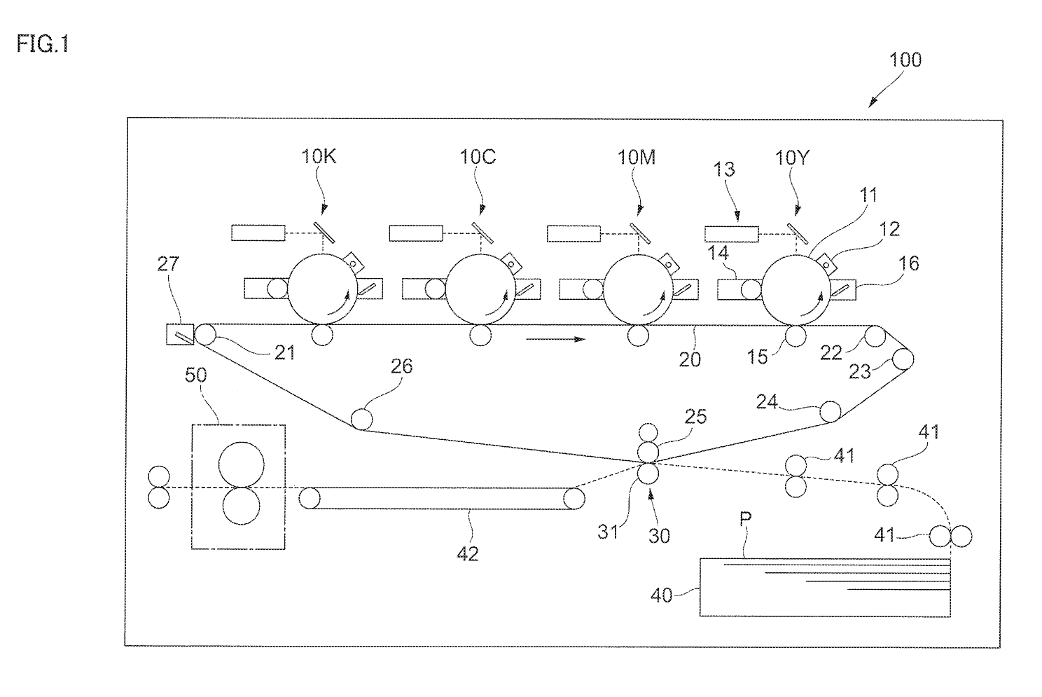

FIG. 1 is a diagram showing an image forming apparatus 100, to which the exemplary embodiment is applied, when viewed from a front side.

The image forming apparatus 100 shown in the figure has a configuration of a so-called tandem type and includes plural image forming units 10 (10Y, 10M, 10C and 10K) for forming toner images of respective color components by the electrophotographic system. Moreover, the image forming apparatus 100 according to the exemplary embodiment is provided with a controller that is configured to include a CPU (Central Processing Unit), a ROM (Read Only Memory), a RAM (Random Access Memory) and others, to thereby control operations of each device and each part constituting the image forming apparatus 100. The toner image is an example of an image.

Moreover, the image forming apparatus 100 includes an intermediate transfer belt 20 to which the toner images of the respective color components formed in the respective image forming units 10 are sequentially transferred (primary transfer) and which holds the toner images of the respective color components, and a secondary transfer device 30 that collectively transfers (secondary transfer) the toner images of the respective color components on the intermediate transfer belt 20 onto a recording material P formed in a rectangular shape. The recording material P is a medium on which fixing is performed, such as paper, film, or the like.

The image forming units 10 are an example of an image forming unit, and the intermediate transfer belt 20 and the secondary transfer device 30 are an example of a transfer unit.

Moreover, the image forming apparatus 100 is provided with a sheet feeder 40 that feeds the recording material P. Moreover, between the sheet feeder 40 and the secondary transfer device 30, plural transport rolls 41 for transporting the recording material P positioned on a sheet transport route are provided.

Moreover, in the exemplary embodiment, a fixing device 50 that fixes the image having been secondarily transferred onto the recording material P by the secondary transfer device 30 onto the recording material P is provided. Further, between the secondary transfer device 30 and the fixing device 50, a transport device 42 that transports the recording material P having passed through the secondary transfer device 30 to the fixing device 50 is provided.

The fixing device 50 is an example of a fixing unit.

Here, each of the image forming units 10 functioning as part of the image forming part includes a photoconductive drum 11 that is rotatably attached. Moreover, around the photoconductive drum 11, there are provided a charging device 12 that charges the photoconductive drum 11, an exposure device 13 that exposes the photoconductive drum 11 to write an electrostatic latent image, and a developing device 14 that visualizes the electrostatic latent image on the photoconductive drum 11 with toner. Further, there are provided a primary transfer device 15 that transfers the toner images of the respective color components formed on the photoconductive drum 11 onto the intermediate transfer belt 20, and a drum cleaner 16 that removes residual toner on the photoconductive drum 11.

The intermediate transfer belt 20 is provided to be disposed on plural roll members 21, 22, 23, 24, 25 and 26 to be rotated. Of these roll members 21 to 26, the roll member 21 is configured to drive the intermediate transfer belt 20. Moreover, the roll member 25 is provided to face the secondary transfer roll 31 with the intermediate transfer belt 20 being interposed therebetween; accordingly, the secondary transfer device 30 is configured with these secondary transfer roll 31 and roll member 25.

Note that, at a position facing the roll member 21 with the intermediate transfer belt 20 being interposed therebetween, a belt cleaner 27 that removes residual toner on the intermediate transfer belt 20 is provided.

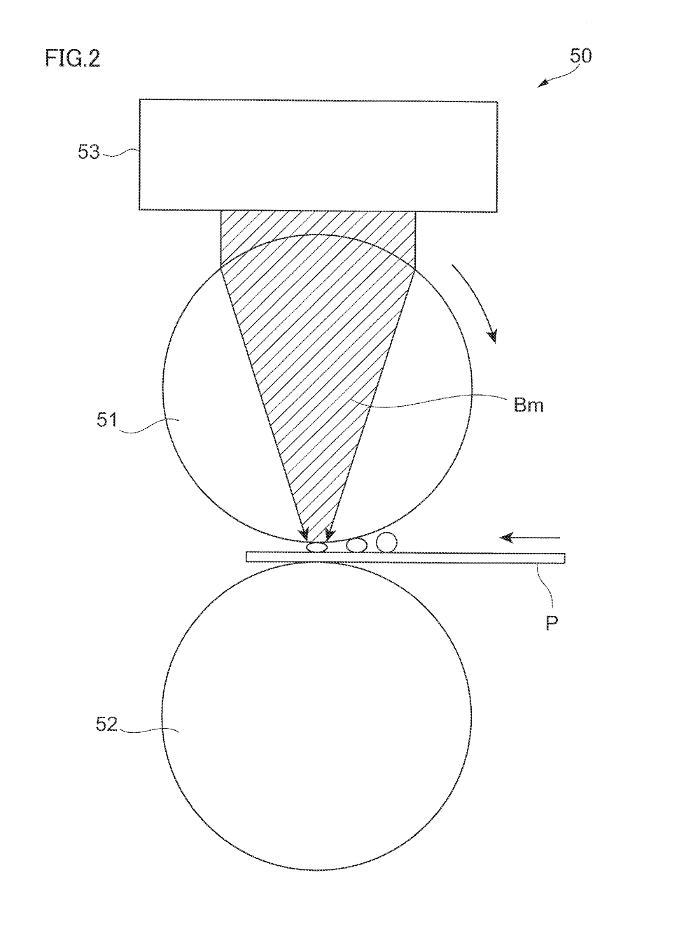

FIG. 2 is a diagram illustrating an outline configuration of the fixing device 50.

As shown in FIG. 2, in the exemplary embodiment, the fixing device 50 includes: a rotatable transparent rod 51 that is configured in a columnar shape with a transparent material capable of transmitting a beam Bm; and a facing roll 52 that is provided to face the transparent rod 51 so that a contact area is formed, the facing roll 52 cooperating with the transparent rod 51, to thereby transport the recording material P.

Moreover, the fixing device 50 includes a light concentrator (linear light concentrator) 53 that makes laser light or the beam Bm, which will be concentrated into a linear region extending over an entire width of a region of the recording material P onto which an image is transferred (narrow light concentration width), enter the transparent rod 51. The transparent rod 51 is an example of a rotating body, the facing roll 52 is an example of a facing member, and the light concentrator 53 is an example of a laser light irradiator.

The fixing device 50 is a laser fixing device that directly heats toner on the recording material P by the beam Bm from the light concentrator 53 concentrated in the linear region, to thereby perform melting-fixing. Note that, by narrowing the width of the linear region, light concentration efficiency is improved, and a fixing portion is rapidly cooled.

“Transparent” in the transparent rod 51 means high transmittance in a wavelength region of the beam Bm, which just has to transmit the beam Bm, and the higher the transmittance is, the better, from a standpoint of light use efficiency or the like. For example, the transmittance may be 90% or more, and desirably, 95% or more.

Moreover, the facing roll 52 is configured with, for example, aluminum, stainless steel, a nickel-plated copper plate or others, and is disposed such that a predetermined pressurizing force is applied between the transparent rod 51 and the facing roll 52. This forms the contact area between the transparent rod 51 and the facing roll 52.

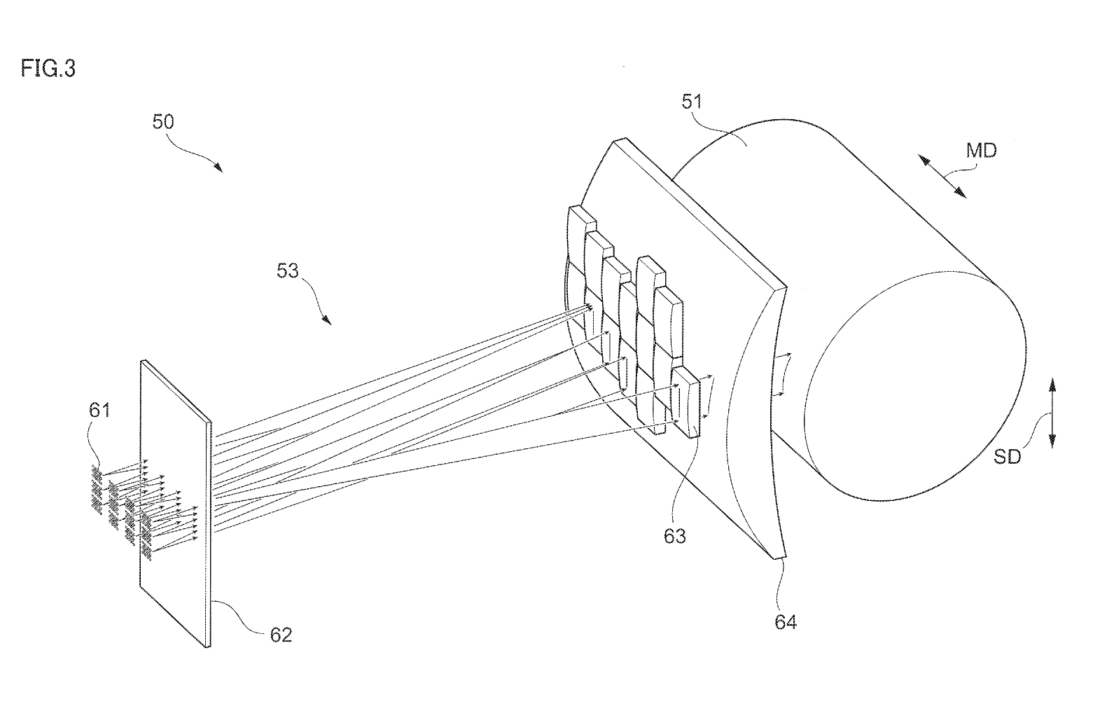

FIG. 3 is a perspective view illustrating the light concentrator 53 of the fixing device 50.

As shown in FIG. 3, the light concentrator 53 is configured to include: a vertical cavity surface emitting laser unit 61 as an example of a light emitting body that emits the beam Bm; a first optical element group 62 that restricts spread of the beam Bm emitted from the vertical cavity surface emitting laser unit 61 in a main direction MD as an example of a first direction; and a second optical element group 63 that collimates the beam Bm from the first optical element group 62 in a sub direction SD as an example of a second direction. The spread of the beam Bm in the sub direction SD is not restricted by the first optical element group 62, and, as shown in the vertical spread of arrows of each beam at the incident position in the second optical element group 63 in FIG. 3, the beam Bm spreads in the sub direction SD and thereafter, is collimated. In the light concentrator 53, the first optical element group 62 and the second optical element group 63 are in positions different from each other, the positions being related to emission direction of the vertical cavity surface emitting laser unit 61. More specifically, between the vertical cavity surface emitting laser unit 61 and the second optical element group 63, the first optical element group 62 is disposed.

Moreover, the light concentrator 53 is configured to include a correction cylinder 64, which is an aspherical cylinder lens that is positioned at a subsequent stage of the second optical element group 63 and corrects aberration characteristics of the transparent rod 51 when light concentration is performed on an exit side surface of the transparent rod 51.

Note that, it can be said that the main direction MD is substantially the same direction as the longitudinal direction of the linear region, whereas, the sub direction SD is substantially the same direction as the transport direction of the recording material P (refer to FIG. 2).

Hereinafter, each configuration of the light concentrator 53 will be described.

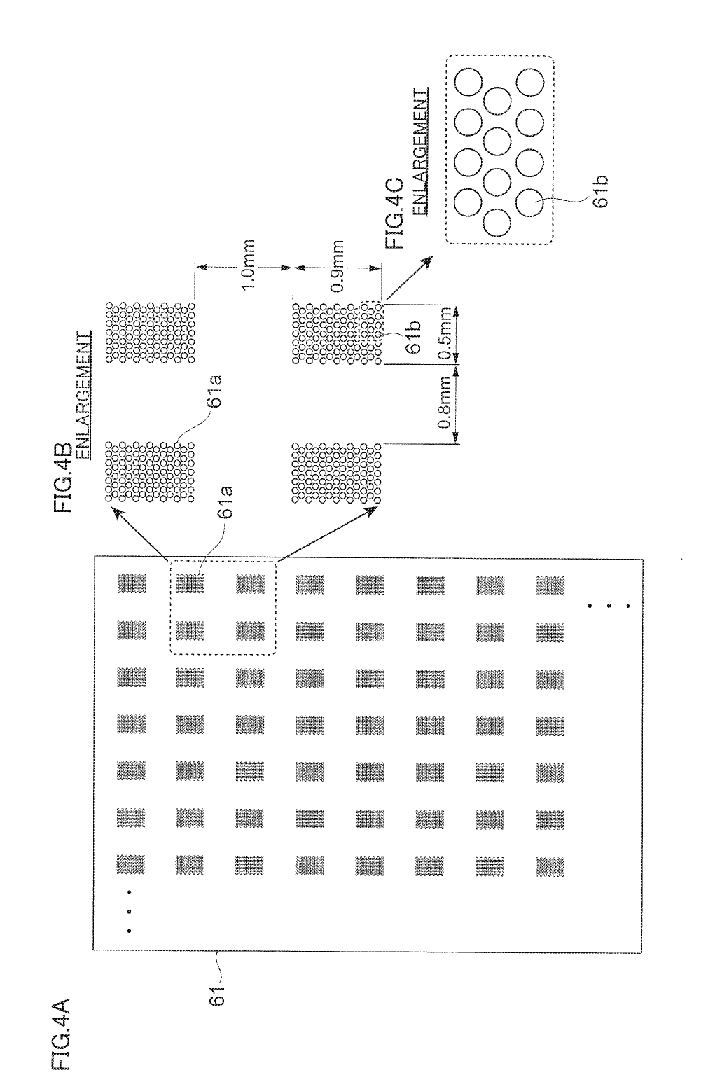

FIGS. 4A to 4C are diagrams for illustrating the vertical cavity surface emitting laser unit 61.

As shown in FIGS. 4A to 4C, the vertical cavity surface emitting laser unit 61 is an areal light emitting element array, and is configured by arranging light emitting element chips 61a, as an example of light emitting surfaces, two-dimensionally or in two directions with gaps therebetween. In the exemplary embodiment, an outer shape of the light emitting element chip 61a is of the size of 0.9 mm×0.5 mm, and the gap therebetween is 1.0 mm in the vertical direction and 0.8 mm in the horizontal direction in FIGS. 4A to 4C. An adjacent chip interval in the vertical direction is 1.9 mm. Moreover, in the exemplary embodiment, as the chip stages in the vertical direction in the figure, 20 stages are arranged.

Such a light emitting element chip 61a gathers plural light emitting elements, or light emitting points 61b, and specifically, the light emitting element chip 61a is configured by densely arranging the light emitting points 61b. In other words, the light emitting element chip 61a is formed by arranging the light emitting points 61b two-dimensionally, and further, the vertical cavity surface emitting laser unit 61 is formed by arranging the light emitting element chips 61a two-dimensionally.

Such light emitting element chips 61a have one-to-one correspondence with sawtooth optical elements, which will be described later, of the first optical element group 62.

Note that, in the exemplary embodiment, since the light emitting element chips 61a is not a high-power edge emitting laser, but the vertical cavity surface emitting laser (VCSEL), the exemplary embodiment adopts a configuration for securing power by the number of light emitting points. Therefore, to serve as a substitute for the power laser, the configuration in which light is concentrated to the linear region by the first optical element group 62 and the second optical element group 63 is adopted to suppress light concentration loss. The beam from the surface of the vertical cavity surface emitting laser unit 61 is concentrated to a line (linearly).

Here, light concentration of emitted light from the vertical cavity surface emitting laser unit 61 will be described. As the light concentration in the above-described vertical cavity surface emitting laser unit 61, there can be considered a case in which reduction imaging is performed for the entire vertical cavity surface emitting laser unit 61, a case in which the reduction imaging is performed by the unit of light emitting element chip 61a, and a case in which light from the light emitting point 61b in the light emitting element chip 61a is collimated.

When the reduction imaging for the entire vertical cavity surface emitting laser unit 61 is performed, for obtaining reduction magnification of 1/50, it is required to set an angle ratio of angle before incidence/angle after incidence to 1/50; accordingly, even when after the angle after incidence is set to the order of 0.5, NA (numerical aperture) can only be of the order of 0.01, and therefore, light concentration efficiency is degraded.

Moreover, when beams from the light emitting points 61b are individually collimated, to collimate respective beams with NA of 0.05 and intervals of 50 μm by a lens array positioned close to the light emitting element chip 61a without producing overlapping beams, it is required to place the lens array at a position 500 μm away of the light emitting element chip 61a; therefore, the optical axes are tilted corresponding to positional deviation of the lens, and the position of light concentration is sensitively changed.

On the other hand, if the light is collimated by the unit of light emitting element chip 61a by the lens array and concentrated by a subsequent-stage lens, the above-described problem does not occur and it becomes easy to secure the reduction magnification of ⅓ (determined by the ratio of the size of the light emitting element chip 61a to the target light concentration width). However, for concentrating plural collimated beams by the subsequent-stage lens, it is necessary to have a distance of almost 100 mm from the light emitting points 61b to the lens array for securing the angle ratio of angle before incidence/angle after incidence corresponding to the reduction magnification, because it is impossible to extremely shorten the focal length of the subsequent-stage lens, and accordingly, as will be described later, it is necessary to prevent the beams of the adjacent elements from overlapping one another and impairing powers to emitted beams.

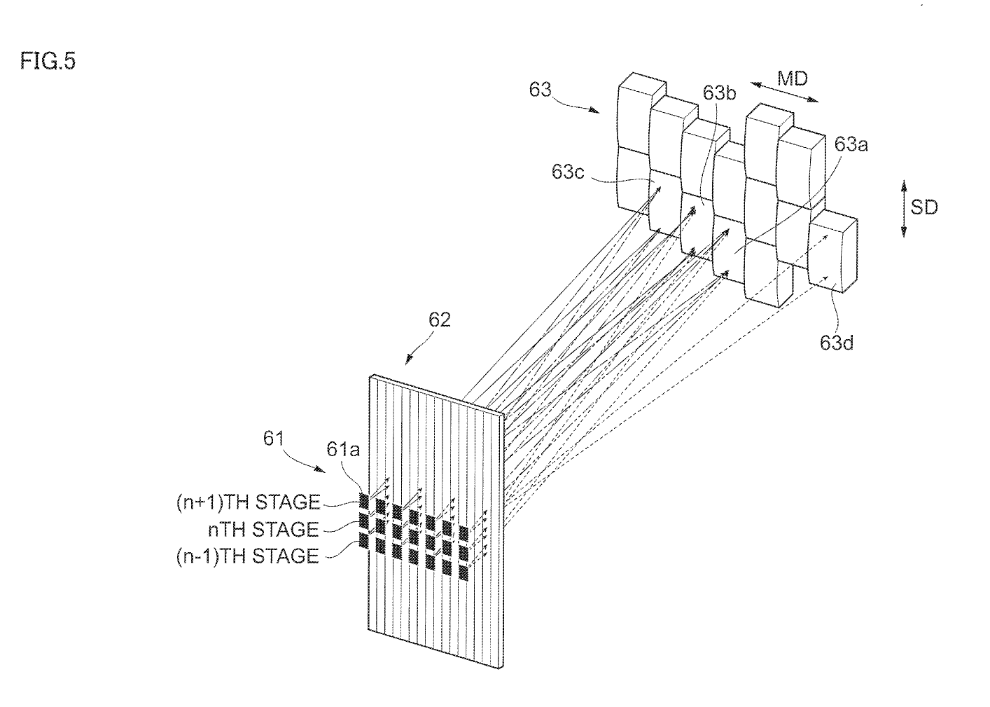

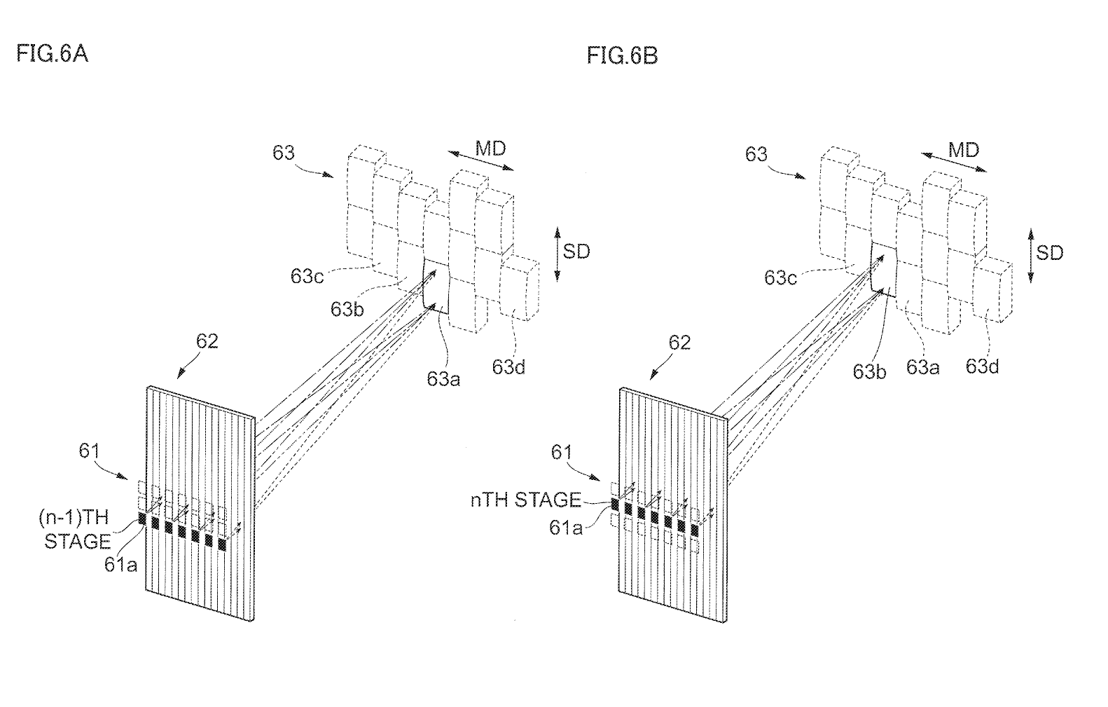

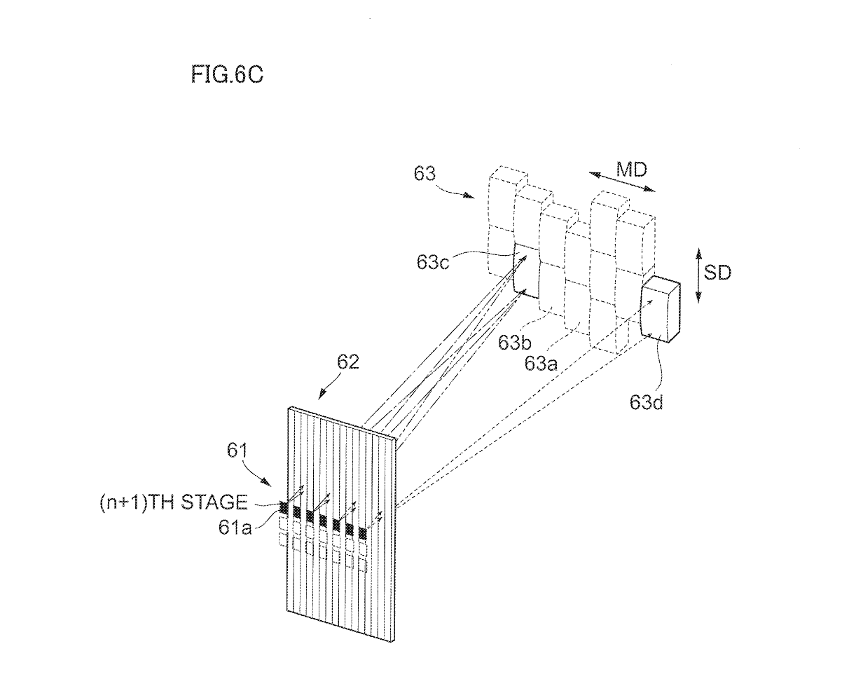

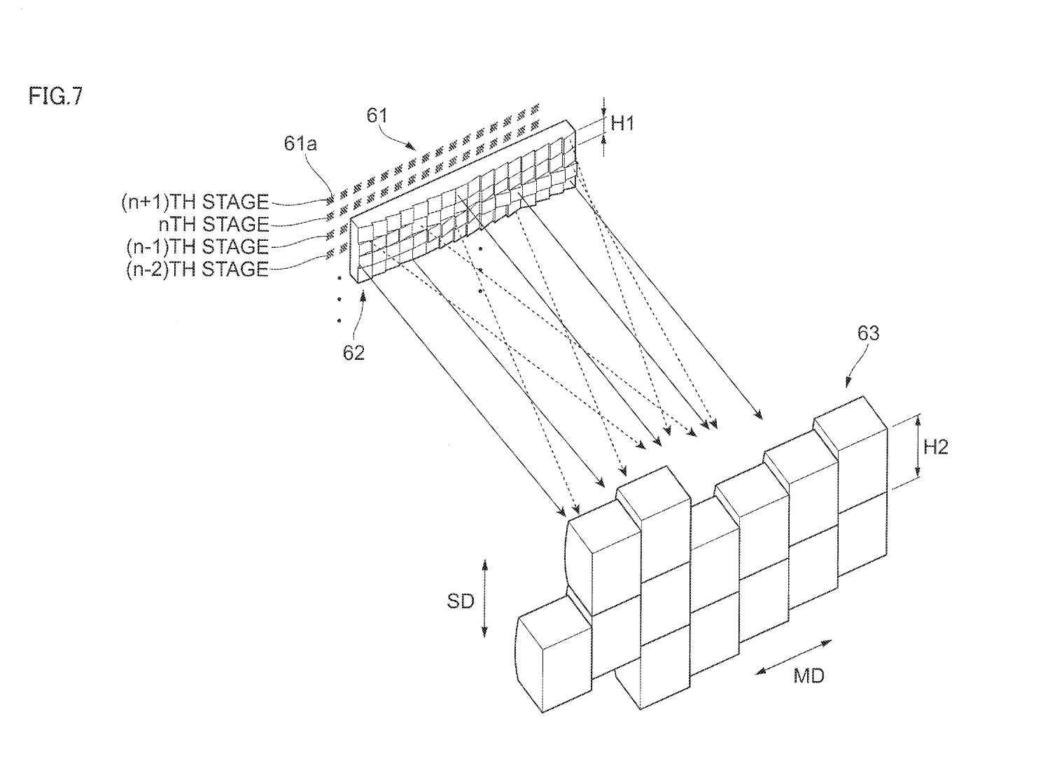

FIG. 5, FIG. 6A, FIG. 6B, 6C, and FIG. 7 are perspective views illustrating a bundle optical system: FIG. 5, FIG. 6A, FIGS. 6B and 6C show a case as viewed in the optical path direction; FIG. 7 shows a case as viewed in a direction opposite to the optical path direction. FIG. 6A, FIGS. 6B and 6C are outline views illustrating light guidance of a bundle optical system shown in FIG. 5 in respective stages.

The bundle optical system described here refers to an optical system for avoiding overlapping of adjacent beams, and includes the first optical element group 62 and the second optical element group 63. In other words, the bundle optical system bundles the beams in the main direction MD by the first optical element group 62 to guide the beams to block cylinder elements of the second optical element group 63, to thereby change the light guidance position to a different block cylinder element shifted in the main direction MD and the sub direction SD for each stage of the light emitting element chips 61a of the vertical cavity surface emitting laser unit 61 different in the sub direction SD and to separate the beams, and thereby overlapping of the beams in the adjacent stages can be avoided.

More specific description will be given. In the bundle optical system shown in FIG. 5, the first optical element group 62 restricts the spread of the beams in the main direction MD, the beams being emitted from the respective light emitting points 61b in the same column, to guide the beams to apertures of the second optical element group 63. The first optical element group 62 is divided in the main direction MD and sub direction SD into first optical elements. In other words, the first optical element group 62 is configured with column-unit cylinders on the incident side shown in FIGS. 5, 6A, 6B and 6C and the sawtooth optical elements on the exit side shown in FIG. 7. The sawtooth optical elements are of the Fresnel-lens type for changing deflection toward the block cylinder elements. By such column-unit cylinders and sawtooth optical elements, deflection characteristics to change the incident beams from the vertical cavity surface emitting laser unit 61 to the exit beams deflected in the main direction MD can be realized. Moreover, the deflection characteristics in the main direction MD of the first optical elements adjacent in the sub direction SD are differentiated by the sawtooth optical elements. This allows the beams from the vertical cavity surface emitting laser unit 61 to be guided to the second optical element group 63 in each stage. Arrows of beams shown in FIGS. 5, 6A, 6B and 6C depict only the representative light emitting points for avoiding complication. Moreover, the spread of the beams in the sub direction SD shows that the spread in the vertical direction is left without being restricted by the first optical elements. The spread of the beams in the sub direction SD is converted into the collimated beams by the block cylinder elements of the second optical element group 63.

The second optical element group 63 is an array of the block cylinder elements. The second optical element group 63 is divided in the main direction MD or divided in the main direction MD and in the sub direction SD into plural second optical elements (block cylinder elements).

Such a second optical element is configured at least on one side of the second optical element group 63, and has power in the sub direction SD, to thereby convert beams diverging in the sub direction SD from the corresponding light emitting element chips 61a into the collimated beams. For this function, between the adjacent second optical elements, positions of center axes of refracting action (corresponding to a generating line in the case of the cylinder surface) are shifted by the difference in the height of the light emitting element chips 61a (position in the sub direction SD) corresponding to the respective second optical elements. When the second optical elements are configured on one side, production costs are reduced and optical requirements are mild as compared to the case of being configured on both sides. On the other hand, when the second optical elements are configured on both sides, curves thereof are gentle as compared to the case of being configured on one side.

As shown in FIG. 5, the column-unit cylinders of the first optical element group 62 are formed to extend in the sub direction SD, and restrict the spread of the beams in the main direction MD, the beams being emitted from the respective light emitting points in the same column of the vertical cavity surface emitting laser unit 61.

Moreover, as shown in FIGS. 5, 6A, 6B, 6C, and 7, the sawtooth optical elements of the first optical element group 62 bundle the beams (form bundled beams) for each group of the light emitting element chips 61a whose positions in the sub direction SD (height positions) are same (that is, on the same stage) so that beams of the light emitting element chips 61a adjacent in the sub direction SD do not overlap each other, and guide the bundled beams toward corresponding apertures 63a, 63b, 63c and 63d of the second optical element group 63. In other words, the beams from the respective light emitting element chips 61a on the (n−1)th stage, nth stage and (n+1)th stage, which are arranged in the positions different from one another in the sub direction SD, are guided by the first optical element group 62 to the apertures of the second optical element group 63 that are different in the main direction MD.

In detail, FIG. 6A shows light guidance of the beams from the light emitting element chips 61a on the (n−1)th stage in the vertical cavity surface emitting laser unit 61 in which the light emitting element chips 61a are arranged two-dimensionally. Moreover, FIG. 6B shows light guidance of the beams from the light emitting element chips 61a on the nth stage, and FIG. 6C shows light guidance of the beams from the light emitting element chips 61a on the (n+1)th stage.

In other words, the beams from the light emitting element chips 61a on the (n−1)th stage are, as shown in FIG. 6A, guided to the aperture 63a of the second optical element group 63 by the sawtooth optical elements of the first optical element group 62. Moreover, as shown in FIG. 6B, the beams from the light emitting element chips 61a on the nth stage are guided to the aperture 63b of the second optical element group 63. Moreover, as shown in FIG. 6C, the beams from the light emitting element chips 61a on the (n+1)th stage are guided to the aperture 63c of the second optical element group 63. In this manner, the beams from the light emitting element chips 61a different in position in the sub direction SD are guided to the corresponding different block cylinder elements, respectively.

Note that, in FIG. 6C, the beams from the light emitting element chips 61a on the (n+1)th stage are guided to the aperture 63c and the aperture 63d, which is other than the aperture 63c, in accordance with the positions related to the main direction MD.

Moreover, in the vertical cavity surface emitting laser unit 61, all the light emitting element chips 61a emit light in a lump; however, a mode for causing a part of the light emitting element chips 61a to emit light can also be considered.

To describe relation of lengths in the sub direction SD between the first optical element of the first optical element group 62 and the second optical element of the second optical element group 63, as shown in FIG. 7, height H2 of the second optical element is higher than height H1 of the first optical element. In other words, the length in the sub direction SD of a unit optical element in the second optical element group 63 is longer than the length in the sub direction SD of a unit optical element in the first optical element group 62. To secure the image forming magnification, it is necessary to arrange the second optical element group 63 behind the first optical element group 62 in the light-emitting optical axis direction of the light emitting element. For the exit beams that are spread wider in the sub direction than the exit beams at the position of the first optical element group 63 in the light-emitting optical axis direction, the light concentration efficiency is increased, as compared to the case that does not employ a configuration like this, by making H2 longer than H1.

The sawtooth optical elements of the first optical element group 62 will be described in more detail.

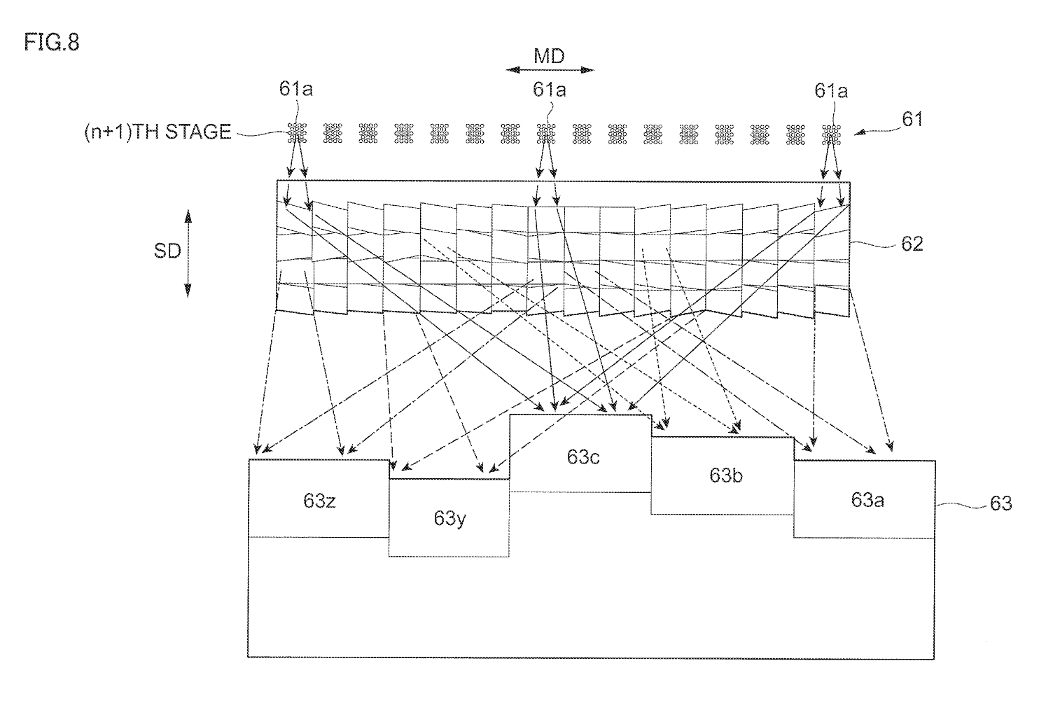

FIG. 8 is a perspective view illustrating the sawtooth optical elements of the first optical element group 62 and is also an outline view seeing down from the same direction as in FIG. 7 in regard to the optical path direction, and shows the sawtooth optical elements in more detail than FIG. 7. Note that, in FIG. 8, the light emitting element chips 61a on the (n+1)th stage in the vertical cavity surface emitting laser unit 61 are shown, and diverging beams emitted from the light emitting points positioned at the center (central light emitting points) of the light emitting points 61b in the light emitting element chip 61a are indicated by solid lines. Moreover, the beams from the nth stage are indicated by dotted lines (short-dashed lines), the beams from the (n−1)th stage are indicated by dot-and-dash lines, and the beams from the (n−2)th stage are indicated by broken lines (long-dashed lines).

As shown in FIG. 8, diverging characteristics of the diverging beams from the central light emitting points are reduced in the main direction MD by the column-unit cylinders of a first surface (surface of the incident side) of the first optical element group 62, and the diverging beams are deflected and guided (bundled) toward the corresponding block cylinder elements of the second optical element group 63 by the sawtooth optical elements of a second surface (surface of the exit side) of the first optical element group 62.

In the first optical element group 62, when plural first optical elements continuously arranged in the main direction MD in the same position related to the sub direction SD (on the same stage) belong to the same group, the corresponding block cylinder element is the same, whereas, such plural first optical elements belong to a different group, the corresponding block cylinder element is different. In other words, the first optical elements in the same position related to the sub direction SD (on the same stage) and continuously arranged in the main direction MD have the same corresponding block cylinder element. The beams from the first optical elements belonging to a different group, even on the same stage, are deflected and guided to a block cylinder element that is in a position different by one cycle.

To put it another way, the plural first optical elements continuously arranged in the main direction MD are assumed as a group (a constitutional unit), and as the deflection characteristics of the first optical elements in the main direction MD, an exit beam group by each group unit is deflected toward an aperture of a corresponding second optical element. In other words, by assuming the plural first optical elements continuously arranged in the main direction MD as the constitutional unit, the exit beam group by such each constitutional unit is deflected and guided to a single block cylinder element. The corresponding block cylinder element is different by each constitutional unit.

More specifically, as shown in FIG. 8, diverging characteristics of the diverging beams from the light emitting element chips 61a on the (n+1)th stage, for example, of the vertical cavity surface emitting laser unit 61 are reduced in the main direction MD at the column-unit cylinders on the incident side of the first optical element group 62, and the diverging beams are deflected and guided toward the corresponding block cylinder elements of the second optical element group 63 by the sawtooth optical elements on the exit side of the first optical element group 62.

In this manner, the column-unit cylinder of the first optical element group 62 has a property to change the incident diverging beams into the exit beams in which the diverging characteristics are reduced in the main direction MD. Moreover, the sawtooth optical elements adjacent to each other in the first optical element group 62 have deflection characteristics in the main direction which are different from each other.

In other words, the first optical elements that are on the same stage and belonging to the same group are deflected and guided to a single block cylinder element. As shown in FIG. 8, for example, the beams from the same group on the (n+1)th stage are guided to the aperture 63c of the block cylinder element of the second optical element group 63 (refer to the solid lines), and the beams from the same group on the nth stage are guided to the aperture 63b (refer to the dotted lines). Moreover, the beams from the same group on the (n−1)th stage are guided to the aperture 63a, whereas the beams from another group on the (n−1)th stage are guided to the different aperture 63z. Moreover, the beams from the same group on the (n−2)th stage are guided to the aperture 63y.

In this manner, beams from a different group, even on the same stage, are deflected and guided to a different block cylinder element. The beams from a different group are deflected and guided to a block cylinder element that is in a position different by one cycle. For avoiding complication, the beams from each group shown in the figure are only the representative ones among the beams belonging to the same group.

Next, a corresponding relation between the bundled beams and the block cylinder elements of the second optical element group 63 will be described. In other words, a corresponding relation between the bundled beams and the block cylinder elements when the beams from the vertical cavity surface emitting laser unit 61 are deflected in the main direction MD by the first optical element group 62 to be guided to the block cylinder elements of the second optical element group 63 will be described.

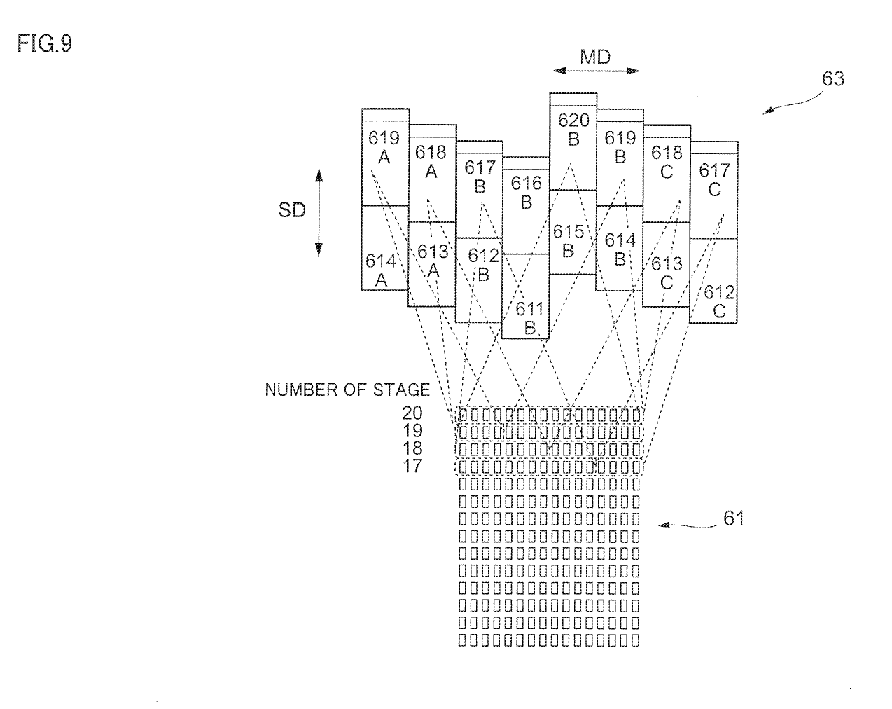

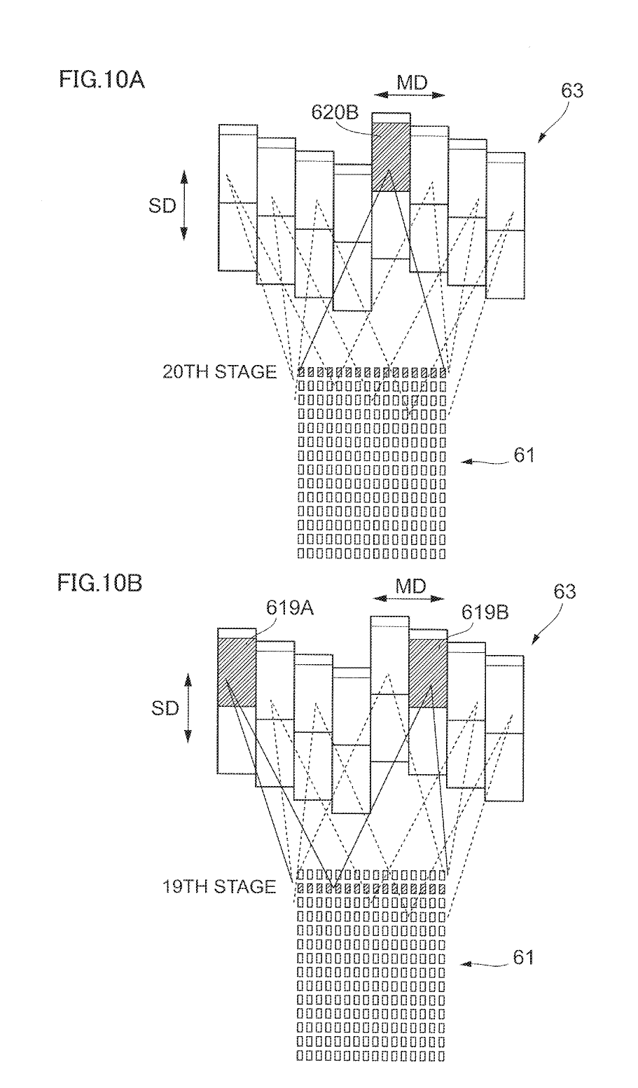

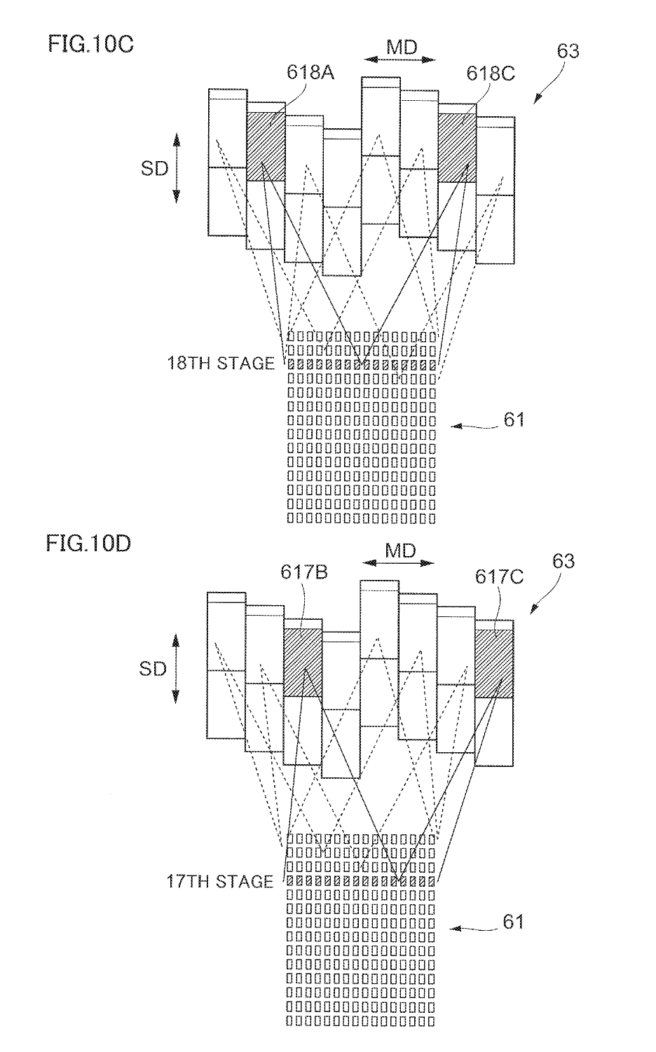

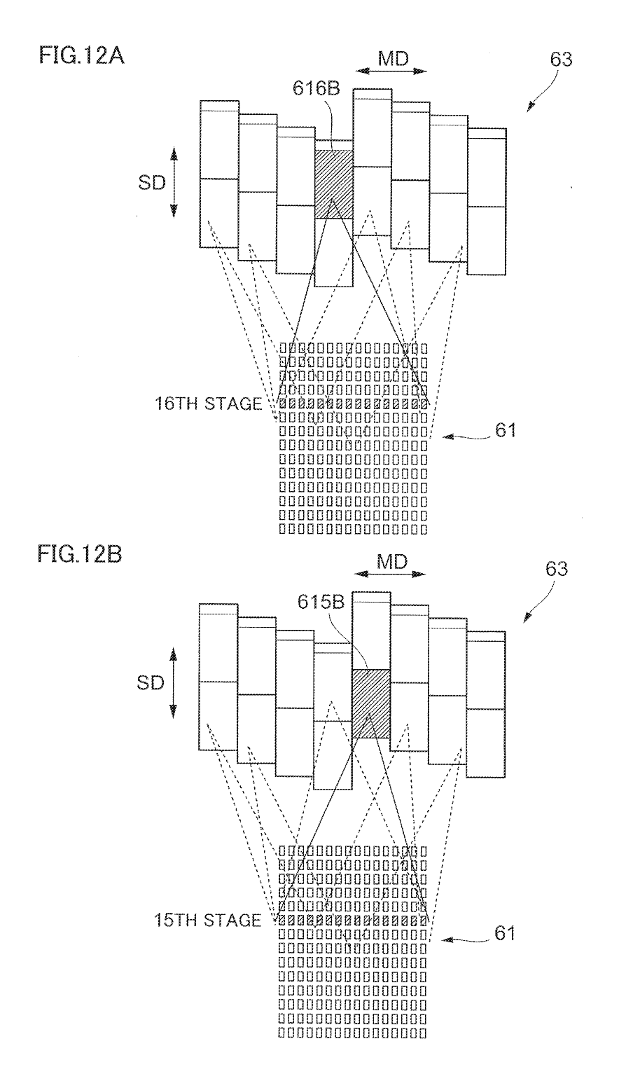

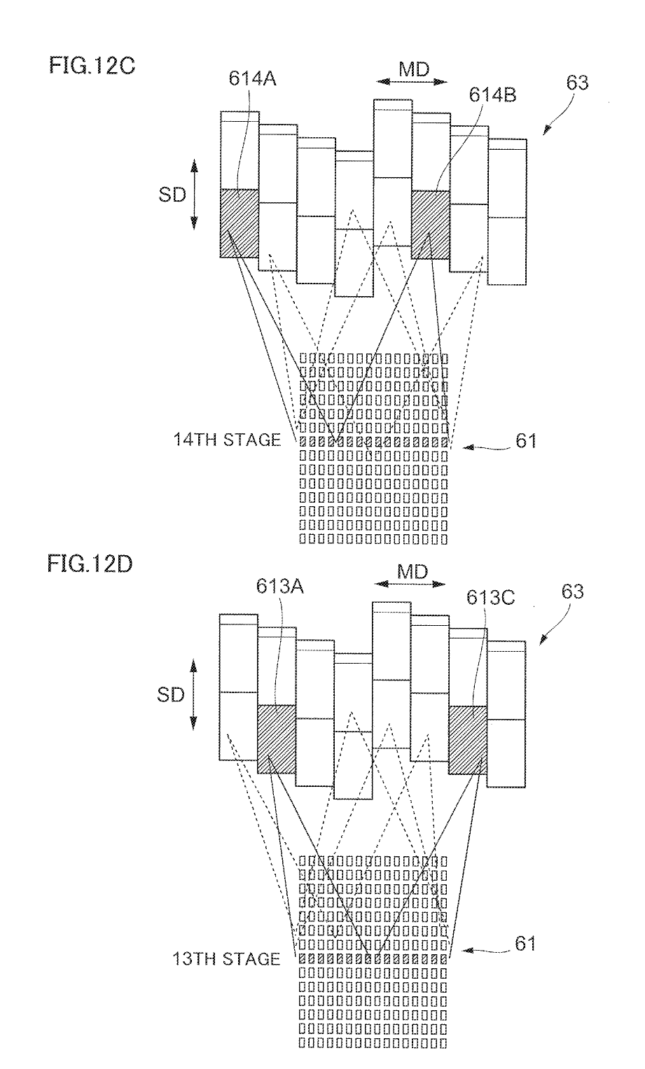

FIGS. 9, 10A, 10B, 10C, 10D, 11, 12A, 12B, 12C and 12D are diagrams illustrating corresponding relations between the bundled beams and block cylinder elements of the second optical element group 63. These figures show the vertical cavity surface emitting laser unit 61 in which the light emitting element chips 61a arranged in the horizontal direction are also disposed on 20 stages vertically to form an areal shape, and the second optical element group 63 divided into 5 stages in the sub direction SD. Note that FIGS. 10A, 10B, 10C and 10D are collectively referred to as “FIG. 10”, and FIGS. 12A, 12B, 12C and 12D are collectively referred to as “FIG. 12” in some cases.

In more detail, FIG. 9 illustrates beam deflection in the upper 4 stages (from the 20th stage to the 17th stage) and corresponding block cylinder elements, and FIG. 10A is a close-up of a corresponding relation in the case of the 20th stage. FIG. 10B is a close-up of a corresponding relation in the case of the 19th stage, FIG. 10C is a close-up of a corresponding relation in the case of the 18th stage, and FIG. 10D is a close-up of a corresponding relation in the case of the 17th stage.

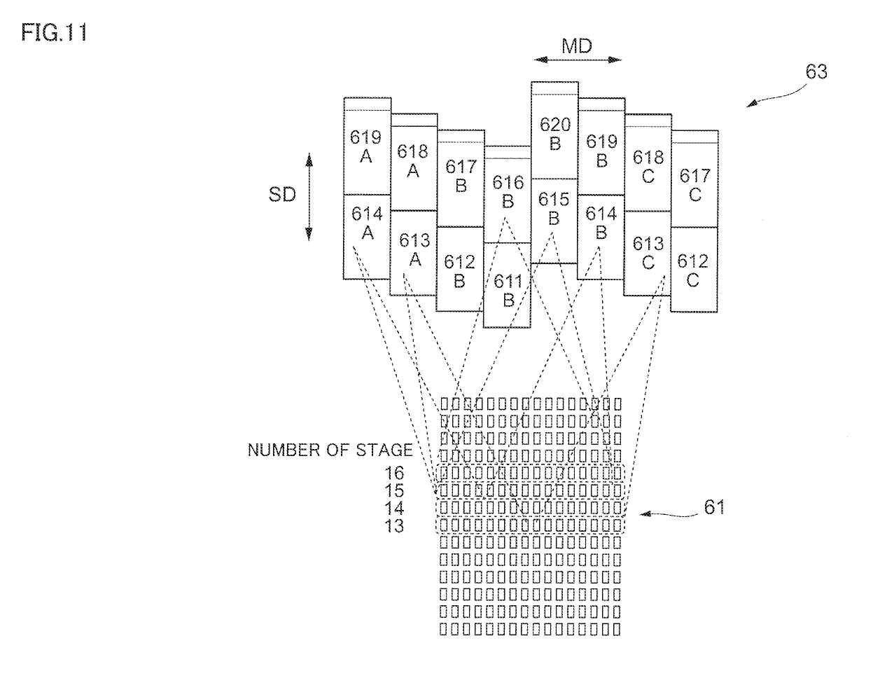

Then, FIG. 11 illustrates beam deflection in the next 4 stages (from the 16th stage to the 13th stage) and corresponding block cylinder elements. FIGS. 12A, 12B, 12C and 12D are close-ups of corresponding relations in the cases of the 16th stage, the 15th stage, the 14th stage and the 13th stage, respectively.

Note that, in the vertical cavity surface emitting laser unit 61, all the light emitting element chips 61a emit light in a lump; however, a mode for causing a part of the light emitting element chips 61a to emit light can also be considered.

Especially, as shown in FIG. 9 or FIG. 11, the bundled beams are deflected so that the converged position is shifted obliquely downward in each stage of all the 20 stages. Therefore, the block cylinder elements 620B (hereinafter, abbreviated as “elements”) and others of the second optical element group 63 are arranged to be shifted in the main direction MD and the sub direction SD. The element 619B adjacent to the element 620B in the main direction MD is shifted in the sub direction SD. In the same manner, the elements 618C and 617C are sequentially shifted in the sub direction SD.

Moreover, regarding the element 615B that is adjacent to the element 620B in the sub direction SD, the element 614B adjacent to the element 615B in the main direction MD is shifted in the sub direction SD, and the elements 613C and 612C are also shifted in the sub direction SD.

Note that, FIGS. 9 to 12D are merely partial illustration of the vertical cavity surface emitting laser unit 61, and illustration in the main direction MD and the sub direction SD is omitted.

The corresponding relation between the bundled beams and the block cylinder elements will be described more specifically.

On the 20th stage of the vertical cavity surface emitting laser unit 61, in the case shown in FIG. 10A, 16 bundled beams are deflected to the element 620B. In the case of the 19th stage shown in FIG. 10B, 4 bundled beams are deflected to the element 619A and 12 bundled beams are deflected to the element 619B. In the case of the 18th stage shown in FIG. 10C, 8 bundled beams are deflected to each of the elements 618A and 618C respectively, and, in the case of the 17th stage shown in FIG. 10D, 12 bundled beams are deflected to the element 617B and 4 bundled beams are deflected to the element 617C.

To describe subsequently, in the case of the 16th stage shown in FIG. 12A, 16 bundled beams are deflected to the element 616B. Moreover, in the case of the 15th stage shown in FIG. 12B, 16 bundled beams are deflected to the element 615B, and, in the case of the 14th stage shown in FIG. 12C, 4 bundled beams are deflected to the element 614A and 12 bundled beams are deflected to the element 614B. Moreover, in the case of the 13th stage shown in FIG. 12D, 8 bundled beams are deflected to each of the elements 613A and 613C respectively.

In this manner, the bundled beams of each stage of the vertical cavity surface emitting laser unit 61 are deflected to the corresponding block cylinder element of the second optical element group 63 by the first optical element group 62.

Here, curvature (radius of curvature) of the column-unit cylinders that restricts spreading of beams in the main direction MD in the first optical element group 62 will be described.

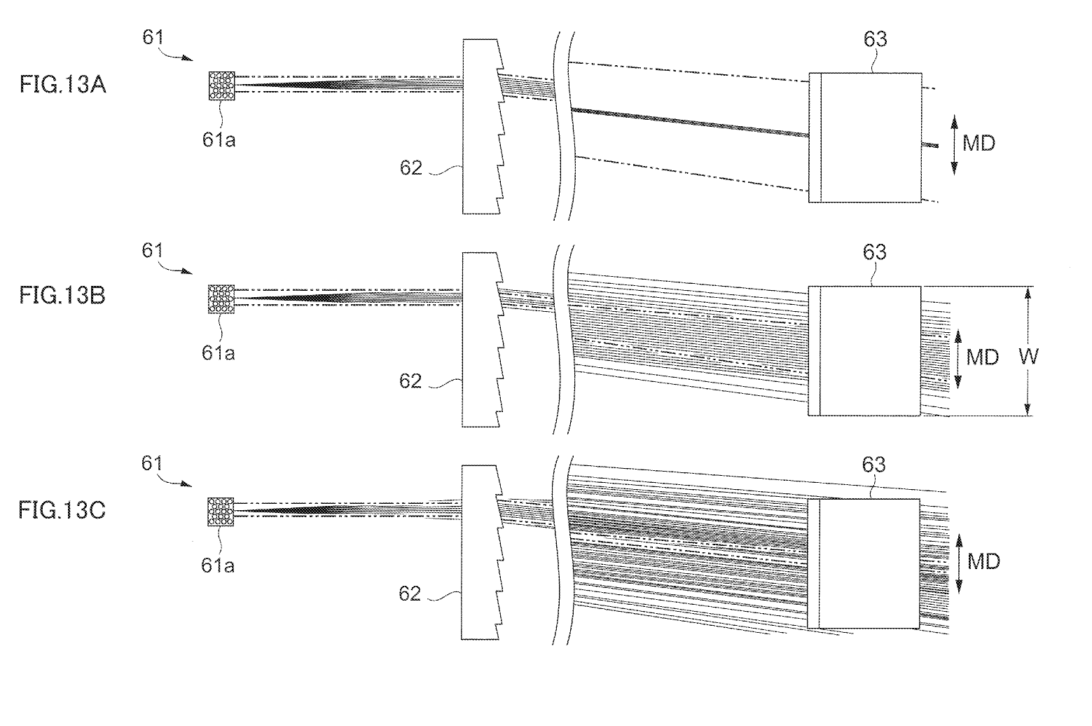

FIGS. 13A to 13C are diagrams illustrating the curvature of the column-unit cylinders. FIGS. 13A to 13C show the cases in which the radii of curvature are different from one another.

In the case of the sharp curvature (r=4 mm) shown in FIG. 13A, though the spread of the central beam from the light emitting element chip 61a of the vertical cavity surface emitting laser unit 61 can be focused in the main direction MD by the column-unit cylinders of the first optical element group 62, the beams from the right and left ends of the light emitting element chips 61a (indicated by chain double-dashed lines) are barely able to enter the aperture of the block cylinder element of the second optical element group 63 due to strong refraction by the column-unit cylinder, to be described later. Therefore, if there is a misalignment, the beams cannot enter the aperture, and thereby light concentration loss occurs.

On the other hand, in the case of the mild curvature (r=20 mm) shown in FIG. 13C, the beams from the right and left ends exactly enter the center of the aperture; however, the entire beams spread out. This case is robust in alignment as compared to the above-described case shown in FIG. 13A, but the light concentration efficiency is deteriorated.

In this manner, as shown in FIG. 13A, when the curvature of the column-unit cylinder (an example of light convergence power in the main direction) is sharp and the beam from the central light emitting point form an image at the position of the block cylinder element of the second optical element group 63, the beams in the optical axis direction from the right and left peripheral light emitting points (the ends of the light emitting element chip 61a) are strongly refracted and cross at a position far less short way of the block cylinder element, and thereafter, enter in the vicinity of periphery of the block cylinder element. In some cases, the beams are deviated due to misregistration of the light emitting element chips 61a in the vertical cavity surface emitting laser unit 61, and are too sensitive to alignment.

Conversely, as shown in FIG. 13C, when the beams in the optical axis direction from the right and left peripheral light emitting points are configured to cross at the position of the block cylinder element, converging power or light gathering power to the diverging beam from the central light emitting point becomes insufficient, and thereby the entrance efficiency is deteriorated.

In contrast, in the case of FIG. 13B, the curvature is a value between the cases of FIG. 13A and FIG. 13C, namely, r=6 mm to 9 mm. In the case of FIG. 13B, the curvature is robust over alignment; therefore, such a value of the curvature can be adopted. However, for securing the light concentration efficiency, the block cylinder element is required to have an aperture width W of the order of 4 chips (about 5 mm). To put it in another way, by setting the aperture width w to the order of 4 chips, it is possible to secure the light concentration efficiency while causing the beams from the right and left ends of a chip to enter a relatively narrow range.

In this manner, the curvature of the column-unit cylinders may be milder than a power to cause the beam from the central light emitting point of the light emitting element chips 61a (solid lines) to form an image at the position of the second optical element group 63, and sharper than the requirements to gather the beams in the optical axis direction from the peripheral light emitting points of the light emitting element chip 61a (chain double-dashed lines) at the position of the second optical element group 63.

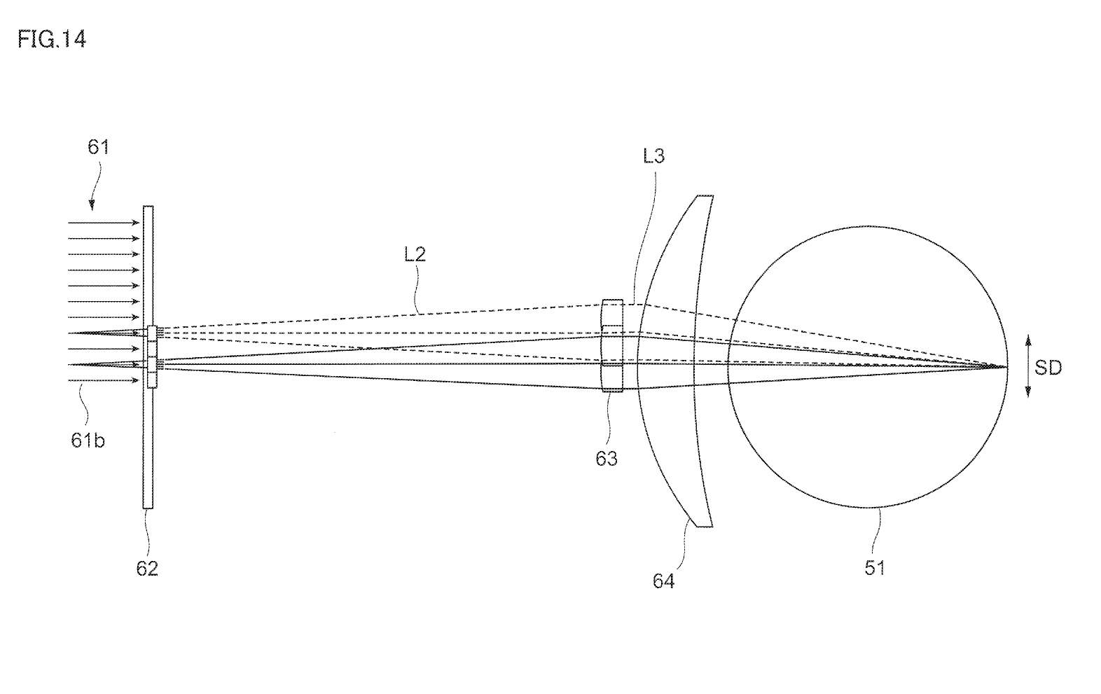

FIG. 14 is a diagram illustrating light concentration by the correction cylinder 64 and the transparent rod 51. In the figure, for the sake of convenience of description, two diverging beams L2, which are paid attention to, are shown.

As described above, the diverging beams from the light emitting points 61b of the vertical cavity surface emitting laser unit 61 are collimated by the second optical element group 63. In other words, as shown in FIG. 14, the two diverging beams L2 enter the block cylinder elements different from each other in the second optical element group 63 to become substantially collimated beams L3, and are concentrated to the linear region by the light concentration lens.

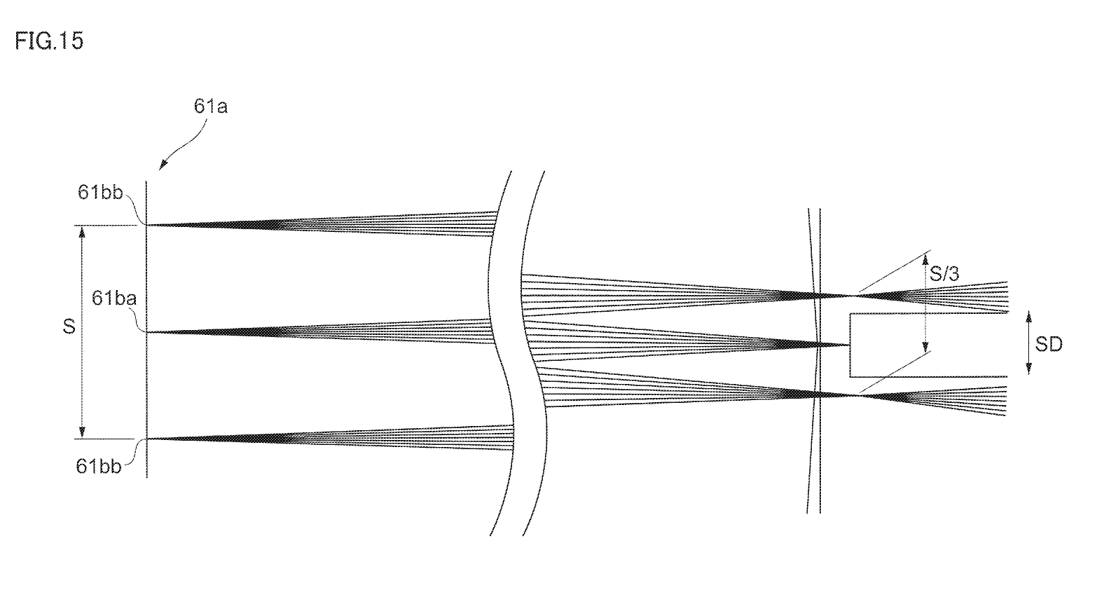

FIG. 15 is a diagram illustrating comparison of an object with an image thereof in reduced projection. In the figure, for the sake of convenience of description, in the vertical cavity surface emitting laser unit 61, the beam from a light emitting point 61ba at the center position and the beams from a light emitting points 61bb at the both end positions of the single light emitting element chip 61a are shown.

By bundling and dividing the beams to avoid overlapping of adjacent beams and securing a distance from the light emitting points 61ba and 61bb to the block cylinder elements, the reduction magnification is secured, and thereby each of the diverging beams from the upper and lower ends within the same light emitting element chip 61a is concentrated to perform reduction imaging of ⅓ size. In other words, as shown in FIG. 15, if it is assumed that the distance between the light emitting points 61bb in the light emitting element chip 61a is S, the distance between the beams becomes S/3 at the light concentration position, and reduction imaging into ⅓ size is performed to obtain the light concentration width (narrow light concentration width) by the effects of the block cylinder element.

Other than the case in which the above-described optical system concentrating the beams from the vertical cavity surface emitting laser unit 61 to the linear region is applied to the light concentrator 53 of the fixing device 50, it can be considered to use the optical system as a linear light concentrator 70.

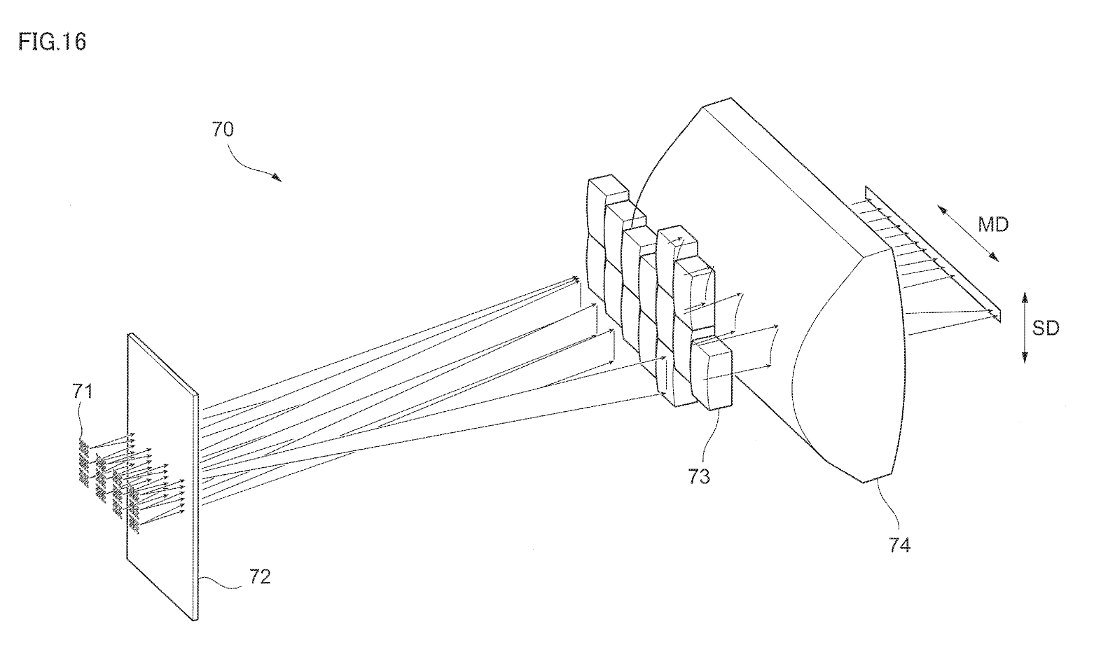

FIG. 16 is a perspective view illustrating the linear light concentrator 70 and corresponds to FIG. 3 that illustrates the light concentrator 53.

As shown in FIG. 16, the linear light concentrator 70 is configured to include a vertical cavity surface emitting laser unit 71, a first optical element group 72, a second optical element group 73 and a cylinder light concentration lens 74. Such a vertical cavity surface emitting laser unit 71 corresponds to the vertical cavity surface emitting laser unit 61 of the light concentrator 53, and accordingly, detailed description thereof will be omitted. Moreover, the first optical element group 72 and the second optical element group 73 of the linear light concentrator 70 correspond to the first optical element group 62 and the second optical element group 63 of the light concentrator 53, and accordingly, detailed description thereof will be omitted.

In the linear light concentrator 70, as the light concentration characteristics of the second optical element group 73 in the sub direction SD, if the diverging beams from the light emitting point 61b (refer to FIGS. 4A to 4C) corresponding to the light emitting point of the vertical cavity surface emitting laser unit 71 are configured to be collimated in the sub direction SD, the beams in the range grouped in the main direction MD are collimated substantially in the sub direction SD, and thereby concentrated to the linear region by placing the cylinder light concentration lens 74 on the subsequent stage.

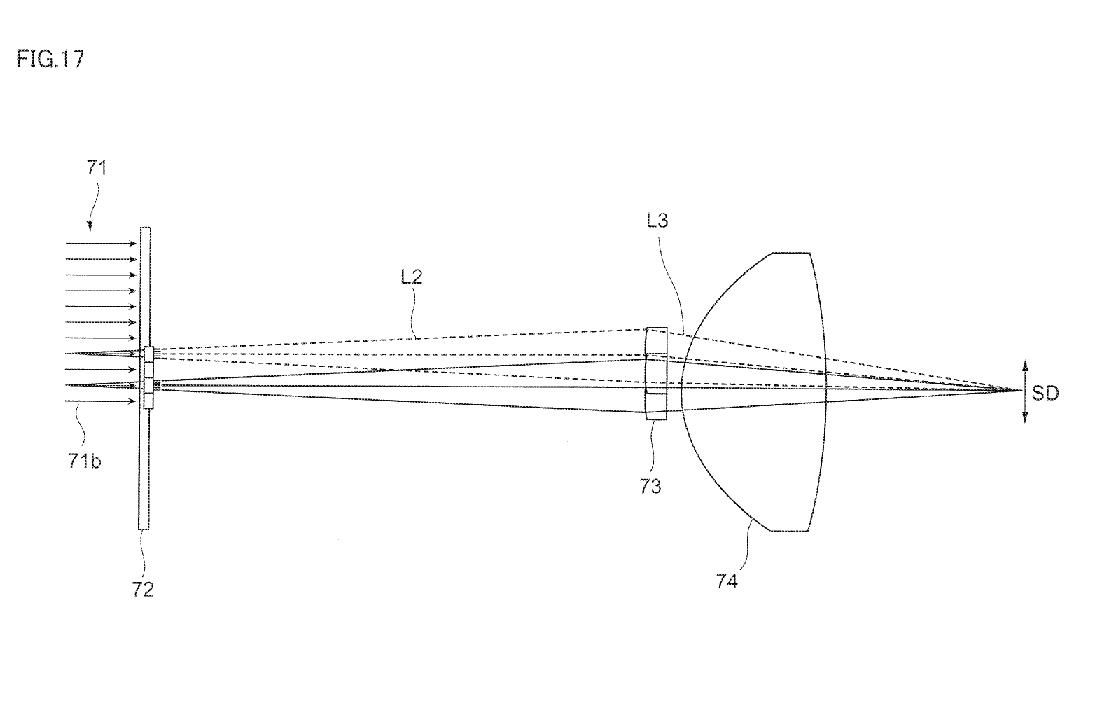

FIG. 17 is a diagram illustrating a light concentration relation of the cylinder light concentration lens 74, and corresponds to FIG. 14 that illustrates the light concentrator 53.

As shown in FIG. 17, the two diverging beams L2 enter the block cylinder elements different from each other in the second optical element group 73 to become substantially collimated beams L3, and are concentrated to the linear region by the cylinder light concentration lens 74.

The foregoing description of the present exemplary embodiment of the present invention has been provided for the purposes of illustration and description. It is not intended to be exhaustive or to limit the invention to the precise forms disclosed. Obviously, many modifications and variations will be apparent to practitioners skilled in the art. The present exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A linear light concentrator comprising:
a light emitting body in which light emitting surfaces are arranged in two directions; and
a first optical element group and a second optical element group that are in different positions from each other related to an emission direction of the light emitting body, wherein
the first optical element group is divided in a first direction and a second direction, which is different from the first direction, into first optical elements, each of the first optical elements having deflection characteristics to change an incident beam from the light emitting body to an exit beam deflected in the first direction, and deflection characteristics in the first direction of the first optical elements that are adjacent in the second direction are different from each other,
at least one side of the second optical element group is divided in at least the first direction into second optical elements having powers in the second direction, and center axes of refracting action of the second optical elements adjacent to each other are disposed to be shifted in the second direction,
when a plurality of the first optical elements continuously arranged in the first direction are assumed to be a constitutional unit, the deflection characteristics of the first optical elements are such that a group of exit beams from each of the constitutional units is deflected toward a corresponding one of apertures of the second optical element group, and
a length of the second optical element in the second direction is longer than a length of the first optical element in the second direction.

2. The linear light concentrator according to claim 1, wherein the first optical element group has a light converging power in the first direction by each of the first optical elements divided in the first direction, the light converging power being weaker than a power that causes a beam from a central light emitting point constituting a part of each of the light emitting surfaces to form an image at a position of the second optical element group, and stronger than a power that converges beams in the optical axis direction from peripheral light emitting points constituting another part of each of the light emitting surfaces at the position of the second optical element group.

3. A fixing device that fixes an image carried on a recording material, comprising:
a rotating body capable of transmitting laser light;
a facing member that is provided to face the rotating body to form a contact region with the rotating body, and cooperates with the rotating body at the contact region to transport the recording material; and
a laser light irradiator that is provided outside the rotating body and irradiates a predetermined position of the rotating body with laser light, wherein
the laser light irradiator comprises:
a light emitting body in which light emitting surfaces each gathering light emitting points are arranged in two directions; and
a first optical element group and a second optical element group that are in different positions from each other related to an emission direction of the light emitting body, wherein
the first optical element group is divided in a first direction and a second direction, which is different from the first direction, into first optical elements, each of the first optical elements having deflection characteristics to change an incident beam from the light emitting body to an exit beam deflected in the first direction, and deflection characteristics in the first direction of the first optical elements that are adjacent in the second direction are different from each other,
at least one side of the second optical element group is divided in at least the first direction into second optical elements having powers in the second direction, and center axes of refracting action of the second optical elements adjacent to each other are disposed to be shifted in the second direction,
when a plurality of the first optical elements continuously arranged in the first direction are assumed to be a constitutional unit, the deflection characteristics of the first optical elements are such that a group of exit beams from each of the constitutional units is deflected toward a corresponding one of apertures of the second optical element group, and
a length of the second optical element in the second direction is longer than a length of the first optical element in the second direction.

4. The fixing device according to claim 3, wherein light converging characteristics of the second optical element group change the beam from the first optical element to a beam substantially parallel to the second direction.

5. An image forming apparatus comprising:
an image forming unit that forms an image;
a transfer unit that transfers the image formed by the image forming unit onto a recording material; and
a fixing unit that fixes the image, which has been transferred onto the recording material, to the recording material, wherein
the fixing unit comprises:
a rotating body capable of transmitting laser light;
a facing member that is provided to face the rotating body to form a contact region with the rotating body, and cooperates with the rotating body at the contact region to transport the recording material; and
a laser light irradiator that is provided outside the rotating body and irradiates a predetermined position of the rotating body with laser light, wherein
the laser light irradiator comprises:
a light emitting body in which light emitting surfaces each gathering light emitting points are arranged in two directions; and
a first optical element group and a second optical element group that are in different positions from each other related to an emission direction of the light emitting body, wherein
the first optical element group is divided in a first direction and a second direction, which is different from the first direction, into first optical elements, each of the first optical elements having deflection characteristics to change an incident beam from the light emitting body to an exit beam deflected in the first direction, and deflection characteristics in the first direction of the first optical elements that are adjacent in the second direction are different from each other,
at least one side of the second optical element group is divided in at least the first direction into second optical elements having powers in the second direction, and center axes of refracting action of the second optical elements adjacent to each other are disposed to be shifted in the second direction,
when a plurality of the first optical elements continuously arranged in the first direction are assumed to be a constitutional unit, the deflection characteristics of the first optical elements are such that a group of exit beams from each of the constitutional units is deflected toward a corresponding one of apertures of the second optical element group, and
a length of the second optical element in the second direction is longer than a length of the first optical element in the second direction.
